(19) United States
(12) Patent Application Publication
(10) Pub. No.: US 2010/0090831 A1
(43) Pub. Date: Apr. 15, 2010

(54) Electronic device with radio frequency identification (RFID) technology

(75) Inventors: Yu Zhao, Wuhan (CN); Hui Yang, Wuhan (CN)

Correspondence Address: PATENT PROSECUTION;O2MIRCO , INC., 3118 PATRICK HENRY DRIVE, SANTA CLARA, CA, 95054, US

(73) Assignee: O2Micro, Inc.

(21) Appl. No.: 12/287,565

(22) Filed: Oct. 9, 2008

(51) Int. Cl. G08B 13/14

(52) U.S. Cl. 340/572.1

(57) ABSTRACT

An electronic device includes a radio frequency identification (RFID) reader and a controller coupled to the RFID reader. The RFID reader is used for detecting an RFID tag when a distance between the RFID tag and the RFID reader is within a predetermined range. The controller is used for enabling the electronic device to operate at an emergency mode when the distance between the RFID tag and the RFID reader is beyond the predetermined range. In the emergency mode, the electronic device is locked.

### TECHNICAL FIELD

Embodiments in accordance with the present invention relate to electronic devices with radio frequency identification (RFID) technology.

### BACKGROUND ART

Portable electronic devices, such as mobile phones become popular because of their convenience and various functions they can provide. For example, a mobile phone can provide functions including wireless communication, playing multi-media files, displaying pictures, providing access to the Internet, transferring text messages, etc. The mobile phone can store data including personal information, such as contact information, account information, and other security information. As a result, if the mobile phone is lost or stolen, it may cause inconvenience to the subscribed user and may also expose the personal/private information of the subscribed user to others.

### SUMMARY OF THE INVENTION

In one embodiment, the present invention provides an electronic device. The electronic device includes a radio frequency identification (RFID) reader and a controller coupled to the RFID reader. The RFID reader is used for detecting an RFID tag when a distance between the RFID tag and the RFID reader is within a predetermined range. The controller is used for enabling the electronic device to operate at an emergency mode when the distance between the RFID tag and the RFID reader is beyond the predetermined range. In the emergency mode, the electronic device is locked.

### BRIEF DESCRIPTION OF THE DRAWINGS

Other objects, advantages, and novel features of the invention will become more apparent from the following detailed description when taken in conjunction with the accompanying drawing.

FIG. 1 is a block diagram of an electronic system, in accordance with one embodiment of the present invention.

FIG. 2 is a block diagram of an electronic system, in accordance with another embodiment of the present invention.

FIG. 3 is a block diagram of an electronic system, in accordance with still another embodiment of the present invention.

FIG. 4 is a software stack block diagram of an electronic device, in accordance with one embodiment of the present invention.

FIG. 5 is an exemplary flowchart showing operations performed by an electronic system, in accordance with one embodiment of the present invention.

### DETAILED DESCRIPTION

Reference will now be made in detail to the embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

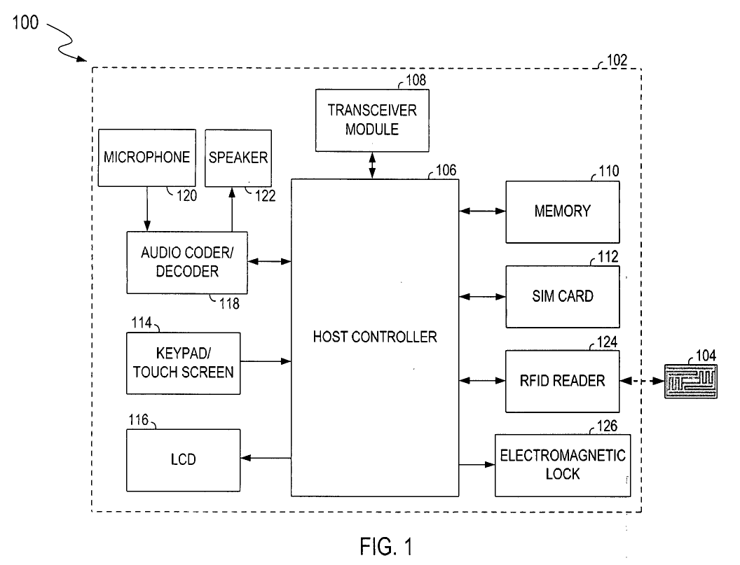

Referring to FIG. 1, an electronic system, e.g., a mobile phone system 100, according to one embodiment of the present invention is illustrated. The mobile phone system 100 includes a mobile phone 102 and a radio frequency identification (RFID) tag 104. The mobile phone 102 includes mobile phone components, such as a host controller 106, a memory 110, a transceiver module 108, a keypad or touch screen 114, a liquid crystal display (LCD) 116, an audio coder/decoder 118, a microphone 120, and a speaker 122, in one embodiment. The mobile phone system 100 can further include a subscriber identity module (SIM) card 112, e.g., in a GSM phone. In one embodiment, the mobile phone 102 further comprises an RFID reader 124 and an electromagnetic lock 126.

As shown in FIG. 1, the memory 110, the SIM card 112, the transceiver module 108, the keypad or touch screen 114, the LCD 116, and the audio coder/decoder 118 are coupled to the host controller 106. The host controller 106 can be, but is not limited to, a micro control unit (MCU), a micro processor unit (MPU), or a digital signal processor (DSP). The host controller 106 can execute software programs stored in the memory 110, and control the hardware of the mobile phone 102. The SIM card 112 stores information that identifies the phone to the network service provider and allows the phone to connect to the network. The SIM card 112 can store information including, but is not limited to, personal identity information, the phone number of the mobile phone 102, directories, and text messages. The transceiver module 108 enables wireless communication and data exchange. The keypad or touch screen 114 is used for inputting user instructions to the mobile phone 102. The LCD 116 displays information to users, such as a menu, calling status, text messages, pictures, and videos. The audio coder/decoder 118 couples the microphone 120 and the speaker 122 to the host controller 106 for converting the human voices to electrical signals and converting electrical signals to human voices.

In accordance with one embodiment of the present invention, the mobile phone 102 can work at an anti-lost mode. In the anti-lost mode, the RFID reader 124 is enabled. The RFID reader 124 includes an antenna circuit for emitting RF waves and generating RF electromagnetic fields. The RFID tag 104 includes a transponder integrated circuit (IC) with an antenna, not shown, for receiving the RF waves. In response to the RF waves, the antenna of the transponder IC generates a faradic current for powering on or actuating the transponder IC of the RFID tag 104. Once powered on or actuated, the RFID tag 104 can communicate with the RFID reader 124.

The RFID tag 104 also stores a unique identification number. The transponder IC modulates the unique identification number into RF signals and transmits the RF signals indicative of the modulated unique identification number. The RFID reader 124 can receive the RF signals indicative of the unique identification number and compare the unique identification number with a known identification number so as to identify the RFID tag 104.

In one embodiment, the RFID reader 124 periodically emits the RF waves. As such, the RFID reader 124 can periodically interrogates the RFID tag 104 through the electromagnetic field. As the power consumption of the RFID reader 124 can be directly proportional to the frequency of emitting the RF waves, the frequency of emitting the RF waves from the RFID reader 124 can be set according to various applications and circumstances for saving power. For example, in public places where the mobile phone 102 is more likely to be stolen, the RFID reader 124 can emit the RF waves per second. Alternatively, in an office or at home, the RFID reader 124 can emit the RF waves per 10 seconds or longer.

The amplitude of the RF waves emitted from the RFID reader 124 varies in accordance with the distance from the RFID reader 124. When the distance between the mobile phone 102 and the RFID tag 104 is within a predetermined effective range, the RF waves emitted from the RFID reader 124 is able to actuate the RFID tag 104, in one embodiment. When the distance between the RFID reader 124 of the mobile phone 102 and the RFID tag 104 is beyond the predetermined effective range, the RFID tag 104 will not be actuated by the RF waves emitted from the RFID reader 124, and will not be detected by the RFID reader 124, in one embodiment. Under this circumstance, an emergency mode will be triggered if the distance between the RFID reader 124 of the mobile phone 102 and the RFID tag 104 is beyond the predetermined effective range.

In one embodiment, the RFID tag 104 can be formed as a tiny card and/or attached to an accessory such as a wallet or belt. When the distance between the RFID reader 124 and the RFID tag 104 is beyond the predetermined effective range (e.g., the user forgets to take the mobile phone 102 along with him or her), the emergency mode will be triggered. Once the mobile phone 102 enters the emergency mode, it will continue working at the emergency mode unless the emergency mode is relieved, e.g., by inputting a correct unlock password or by authenticating a fingerprint by the subscribed user. Alternately, the emergency mode can be automatically relieved if the distance between the RFID reader 124 and the RFID tag 104 is within the predetermined effective range. In this embodiment, the RFID reader 124 will emit the RF waves at the emergency mode, and the emergency mode can be relieved once the RFID reader 124 actuates and detects the RFID tag 104.

In one embodiment, the mobile phone 102 will be locked in the emergency mode. In this embodiment, unless a correct unlock password or an authorized fingerprint is inputted, the keypad or touch screen 114 of the mobile phone 102 is locked and all the other input instructions will be invalid so as to prevent the mobile phone 102 from being used by unauthorized people or from being shut down. An alert message for the emergency status can be shown. In one embodiment, the mobile phone 102 further comprises the electromagnetic lock 126 for locking the battery of the mobile phone 102. In the emergency mode, the host controller 106 of the mobile phone 102 will trigger the electromagnetic lock 126 to lock the battery of the mobile phone 102 such that the battery can not be removed. Thus, the mobile phone 102 can be powered to execute various security procedures, which will be described hereinafter in detail. Further, the speaker 122 will sound an alarm. The alarm of the speaker 122 can be unique such that the user can become aware of the emergency mode. The speaker 122 can continue sounding the alarm unless the emergency mode is relieved.

In accordance with one embodiment of the present invention, security procedures will be executed after the emergency mode has been triggered for a predetermined period of time. The security procedures are used for protecting personal/security information of the subscribed user. The security procedures can include, but are not limited to, hiding, erasing, encrypting, or transferring the security data stored in the memory 110 or the SIM card 112 of the mobile phone 102. The security data can include, but is not limited to, contact information (e.g., phone numbers, addresses, etc.), emails, text messages, downloaded documents, memorandums, and various account names/numbers and passwords. In one embodiment, the subscribed user can predefine the scope of the security data.

In another embodiment, when the user finds that the mobile phone 102 is lost or stolen, he/she can use another mobile, not shown, to send a predefined command, for example, in the form of a SMS message, to the mobile phone 102. Alternately, the predefined command can be sent by a mobile network operator or a mobile manufacturer. After the predefined command is received, the security procedures can be triggered and performed. In one embodiment, the security data in the mobile phone 102 will be deleted/erased. In another embodiment, the security data in the mobile phone 102 can be encrypted, such that others can not open and access to the encrypted data. As such, the security data in the mobile phone 102 can be protected.

In another embodiment, a data transfer program of the security procedures is provided. The data transfer program can be automatically executed after the emergency mode has been triggered for a predetermined period of time, or can be executed in response to a detection of an unauthorized subscriber identity module (SIM) card, or can be executed in response to the predefined command. The data transfer program allows the mobile phone 102 to transfer the security data in the mobile phone 102 to another mobile phone designated by the user, or to the mobile phone which sends the predefined command.

In another embodiment, as the security data is transferred to another mobile phone, the security data can be further used to track the mobile phone 102. The transferred security data can also include additional information, such as the phone number of the unauthorized SIM card, an international mobile equipment identity (IMEI), an international mobile subscriber identity (IMSI), and area code and cell ID of GSM network. With such additional information, the user can contact the person who has his/her mobile phone 102, or contact the mobile network operator to locate the mobile phone 102.

Moreover, the RFID reader 124 can emit RF waves at various RFID frequencies, in accordance with embodiments of the present invention. For example, the RFID reader 124 can emit RF waves at a low frequency (e.g., less than 135 KHz), at a high frequency, (e.g., 13.56 MHz), and at an ultra high frequency, (e.g., 869 or 915 MHz), and the predetermined effective range of the RF waves is approximately one meter. Also, the RFID reader 124 can emit microwave RF waves, for example, having a frequency 2.45 GHz and a predetermined effective range of the RF waves is approximately three meters.

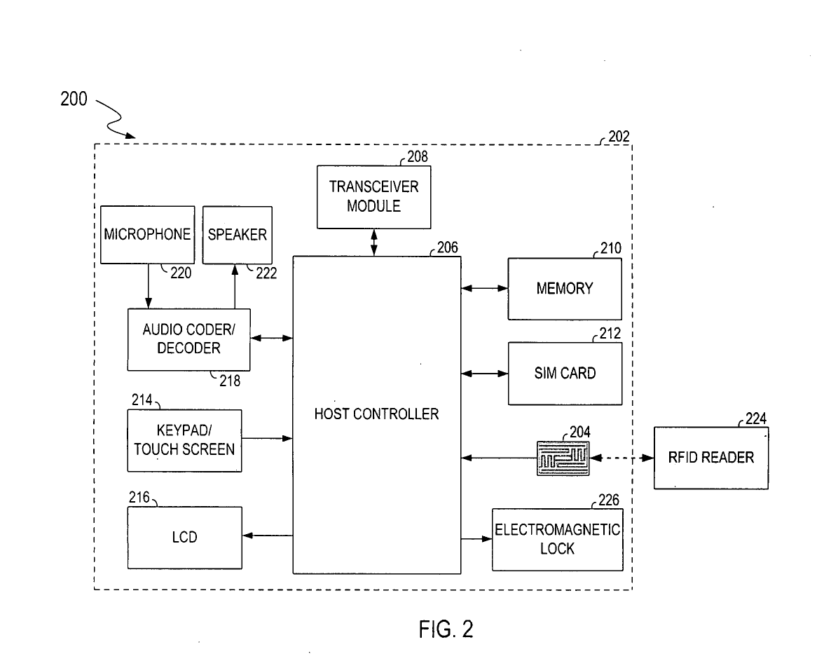

Referring to FIG. 2, an electronic system, e.g., a mobile phone system 200, according to another embodiment of the present invention is illustrated. The mobile phone system 200 is similar to the mobile phone system 100 shown in FIG. 1. The mobile phone system 200 includes a mobile phone 202 having an RFID tag 204, and an RFID reader 224 apart from the mobile phone 202. Elements labeled the same as in FIG. 1 have similar functions and will not be detailed described hereinafter in detail.

In this embodiment, the RFID reader 224 can also be formed as a tiny device and/or attached to an accessory such as a wallet or belt. The RFID reader 224 can be powered by a battery, such as a button battery. The RFID reader 224 periodically emits RF waves to interrogate the RFID tag 204. When the distance between the mobile phone 202 and the RFID reader 224 is within a predetermined effective range, the RFID tag 204 can be actuated and detected by the RFID reader 224. The RFID tag 204 generates a faradic current in response to the RF waves, modulates a unique identification number into RF signals, and transmits the RF signals indicative of the modulated unique identification number. The RFID reader 224 receives the RF signals indicative of the unique identification number and compares the unique identification number with a known identification number so as to identify the RFID tag 204. Once the RFID tag 204 is identified, the electromagnetic between the RFID reader 224 and the RFID tag 204 can be established, and the RFID tag 204 generates a response signal to the host controller 206. The mobile phone 202 will operate in a normal mode. On the contrary, when the distance between the mobile phone 202 and the RFID reader 224 is beyond the predetermined effective range, the RFID tag 204 in the mobile phone 202 will not sense the RF waves from the RFID reader 224 and will not generate the response signal to the host controller 206, in one embodiment. Under this circumstance, the host controller 206 will enable the emergency mode and trigger the security procedures.

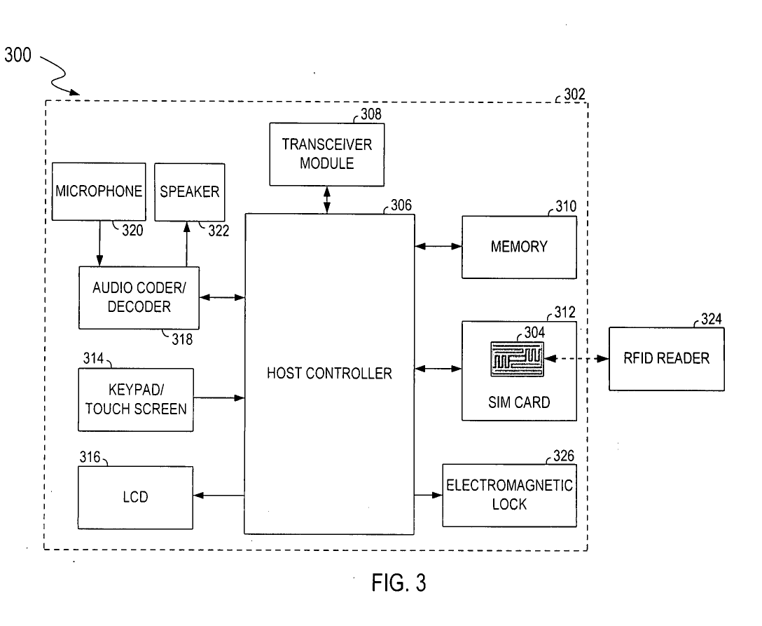

Referring to FIG. 3, an electronic system, e.g., a mobile phone system 300, according to still another embodiment of the present invention is illustrated. The mobile phone system 300, which includes a mobile phone 302 and an RFID reader 324, is similar to the mobile phone system 200 shown in FIG. 2. The mobile phone 302 has a SIM card 312. In one embodiment, an RFID tag 304 is integrated into the SIM card 312, such that the SIM card 312 can be detected by the RFID reader 324 within a predetermined effective range. When the SIM card 312 is inserted into a mobile phone, the mobile phone can be equipped with an anti-lost function. Once the distance between the RFID tag 304 and the RFID reader 324 is beyond the predetermined effective range, the mobile phone 302 will sound an alarm and be locked, and the security data stored therein can be hidden, erased, encrypted, or transferred, in one embodiment. The SIM card 312 with the RFID tag 304 can be inserted to another mobile phone so as to equip that mobile phone with the anti-lost function.

In another embodiment, the RFID reader 324 can sound the alarm when the distance between the RFID tag 304 and the RFID reader 324 is beyond the predetermined effective range.

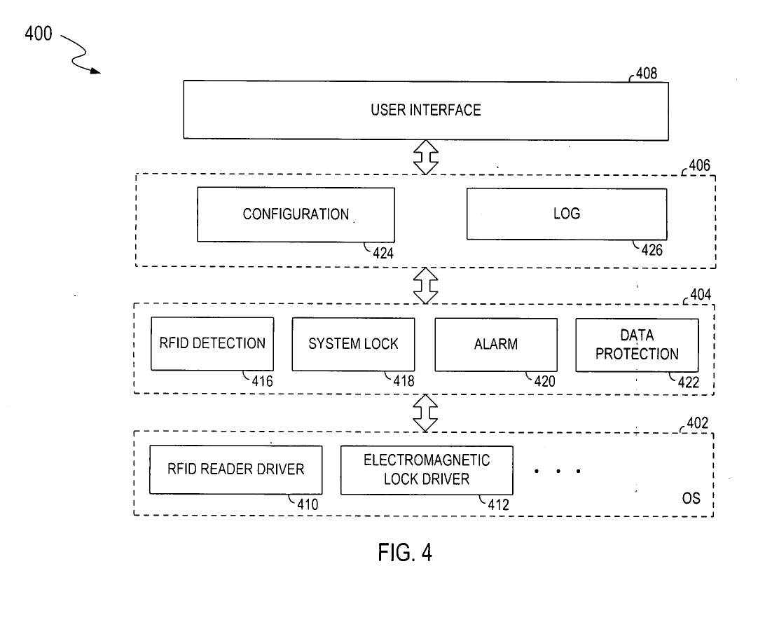

Referring to FIG. 4, a software stack 400 of an electronic device (e.g., a mobile phone) according to one embodiment of the present invention is illustrated. The software stack 400 can be implemented as a software program and installed in the mobile phone system 100 shown in FIG. 1, or the mobile phone system 200 shown in FIG. 2, or the mobile phone system 300 shown in FIG. 3. The software stack 400 is described in combination with the mobile phone system 100 as an example. The software stack 400 includes a plurality of software modules, and is stored in the memory 110. The host controller 106 can load and execute the software modules of the software stack 400 to initialize and control corresponding hardware of the mobile phone 102. The software stack 400 includes four layers placed in series: an operating system (OS) layer 402, an application layer 404, a configuration and management layer 406, and a user interface (UI) layer 408, in one embodiment.

The OS layer 402 is at the bottom of the software stack 400 and is a foundation of the other three layers. The OS layer 402 includes an operating system (OS). For example, according to different embodiments, the OS can be Linux, Symbian, Windows Mobile, Windows CE, Palm OS, etc. The OS layer 402 includes device drivers which can interact with the hardware. The host controller 106 can control the hardware by the device drivers. For example, the RFID reader 124 is controlled through an RFID reader driver 410, and the electromagnetic lock 126 is controlled through an electromagnetic lock driver 412.

The application layer 404 is operated on the platform of the OS layer 402. An application programming interface (API) can support communication between the application layer 404 and the OS layer 402. The application layer 404 includes several functional modules designed for a plurality of particular functions. More specifically, in one embodiment, in order to provide the anti-lost function, the application layer 404 includes an RFID detection module 416, a system lock module 418, an alarm module 420 and a data protection module 422.

The RFID detection module 416 functions when the mobile phone 102 works at the anti-lost mode. The RFID detection module 416 recalls the RFID reader driver 410 to control the RFID reader 124. The RFID reader 124 periodically emits RF waves to interrogate the RFID tag 104. The RFID tag 104 will be actuated and detected by the RFID reader 124 while the distance therebetween is within the predetermined effective range. On the contrary, the RFID tag 104 will not be actuated and detected when the distance between the RFID tag 104 and the RFID reader 124 is beyond the predetermined effective range. In this situation, a trigger signal will be generated to enable the mobile phone 102 to work at the emergency mode.

In the emergency mode, the system lock module 418 disables the keypad or touch screen 114, the audio coder/decoder 118, and the LCD 116 through corresponding drivers in the OS layer 402, in one embodiment. The alarm module 420 triggers an alarm through the speaker 122. The data protection module 422 can hide, erase, encrypt, or transfer security data stored in the memory 110, the SIM card 112, and/or a flash media card (not shown). According to different embodiments, different encryption algorithms can be applied, such as Digital Signature Standard (DSS) or DSA (Digital Signature Algorithm), EIGamal, Data Encryption Standard (DES), and International Data Encryption Algorithm (IDEA).

The configuration and management layer 406 is adjacent to the application layer 404, and includes a configuration module 424 and a log module 426. The configuration module 424 can be used for configuring functional modules in the application layer 404 with proper operating parameters. For example, when the RFID detection module 416 is recalled, the configuration module 424 will set proper operating parameters for the RFID detection module 416, such as the frequency of emitting the RF waves. The configuration module 424 can also be used to control functional modules in the application layer 404 such that the functional modules can cooperate properly. For example, when the emergency mode is triggered, the configuration module 424 will arrange the system lock module 418, the alarm module 420, and the data protection module 422 to operate in sequence. The log module 426 can be used for recording every happened event. For example, time and date at which the emergency mode occurs can be recorded.

The UI layer 408 at the top of the software stack 400 provides the user a window to input his/her instructions. In one embodiment, the UI layer 408 can be a popular graphical user interface (GUI). In response to an input instruction, the configuration and management layer 406 recalls, configures, and organizes corresponding functional modules in the application layer 404.

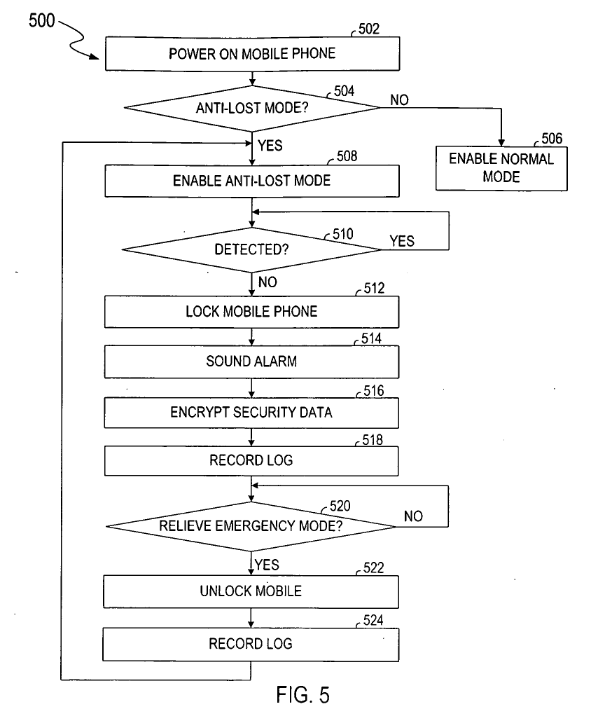

Referring to FIG. 5, an exemplary flowchart 500 of operations performed by an electronic device, e.g., a mobile phone, according to one embodiment of the present invention is illustrated. The flowchart 500 can be implemented as a program and written in one or more forms of programming languages, such as compiled or interpreted languages, and it can be formed, for example, as a stand-alone program or as a module, component, subroutine, or other unit suitable for being executed by a mobile phone. The mobile phone can include an RFID reader for monitoring an RFID tag. The RFID tag can be actuated and detected by the RFID reader within a predetermined effective range, and then can be electromagnetically coupled to the RFID reader.

In block 502, the mobile phone is powered on. Hardware of the mobile phone, such as a host controller; a memory and a plurality of peripherals, is initiated. Device drivers for the hardware of the mobile phone are loaded. Applications are configured and started up.

In block 504, the user will determine whether an anti-lost mode will be enabled. The mobile phone can work at the anti-lost mode or a normal mode. A prompt may be provided and shown on the screen of the mobile phone. If the user determines to enable the anti-lost mode, then the flowchart 500 goes to block 508. Otherwise the flowchart 500 goes to block 506. In block 506, the mobile phone will be enabled to work at the normal mode in which the RFID reader will not be enabled. In another embodiment, the anti-lost mode can be enabled automatically after the mobile phone is powered on. The anti-lost mode can be disabled by the user later and switched to the normal mode.

In block 508, the mobile phone is enabled to work at the anti-lost mode. The RFID reader can be powered on and periodically emit RF waves to interrogate the RFID tag. The emitting frequency can be adjusted according to various needs.

In block 510, the mobile phone determines whether the RFID tag is detected. When the distance between the RFID tag and the RFID reader is within the predetermined effective range, the RFID tag can be actuated and detected by the RFID reader. If the RFID tag is not detected, then the flowchart 500 goes to block 512. Otherwise the flowchart 500 goes back to block 510.

In block 512, the mobile phone enters an emergency mode. In the emergency mode, the mobile phone can be locked. For example, unless a correct unlock password or an authorized fingerprint is inputted, the keypad or touch screen of the mobile phone will not function, and all the other input instructions will be invalid. Furthermore, an electromagnetic lock can lock the battery of the mobile phone such that the battery of the mobile phone can not be removed. Thus, the mobile phone can be powered to execute various security procedures.

In block 514, an alarm can be sounded to notice or warn the subscribed user of the mobile phone. In block 516, a data protection procedure can be enabled. Security data stored in the SIM card or a removable flash memory card of the mobile phone can be hidden or deleted/erased, in one embodiment. Alternately, the security data can be encrypted by an encryption algorithm, in one embodiment. Even if the SIM card or flash memory card is inserted in a new mobile phone, the encrypted security data cannot be accessed unless a correct unlock password or an authorized fingerprint is entered or the RFID tag is within the predetermined effective range of the RFID reader, in one embodiment. In yet another embodiment, the security data can be transferred to another mobile phone through SMS messages or GPRS.

In block 518, the event of the emergency mode can be recorded in the log. For example, the time and the date at which the emergency mode occurred can be recorded. In block 520, the mobile phone can determine whether the emergency mode is relieved. If the emergency mode is not relieved, then the flowchart 500 goes back to block 520. Otherwise the flowchart 500 goes to block 522.

In block 522, the mobile phone is unlocked and can operate at the anti-lost mode. The alarm can be stopped. The encrypted security data can be decrypted and accessed. In block 524, the unlock event can also be recorded in the log and the flowchart 500 will turn to the block 508.

Accordingly, embodiments of the present invention provide an electronic device can be equipped with an RFID reader or a RFID tag. The electronic device can work at an emergency mode when a distance between the RFID reader and the RFID tag is beyond a predetermined effective range. In the emergency mode, the electronic device can be locked and sound an alarm. The emergency mode can be relieved by inputting a correct unlock password or by authenticating a fingerprint by the subscribed user. The electronic device can include, but is not limited to, a mobile phone, a personal digital assistant (PDA), a media player, a GPS receiver, a game machine, a laptop.

While the foregoing description and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. An electronic device comprising:
a radio frequency identification (RFID) reader for detecting an RFID tag when a distance between said RFID tag and said RFID reader is within a predetermined range; and
a controller coupled to said RFID reader for enabling said electronic device to operate at an emergency mode in which said electronic device is locked when said distance between said RFID tag and said RFID reader is beyond said predetermined range.

2. The electronic device as claimed in claim 1, further comprising:
a speaker for sounding an alarm in said emergency mode.

3. The electronic device as claimed in claim 1, further comprising:
a keypad for inputting a user instruction, wherein said keypad is locked in said emergency mode.

4. The electronic device as claimed in claim 3, wherein said emergency mode is relieved if a correct unlock password is inputted to said keypad.

5. The electronic device as claimed in claim 1, further comprising:
a memory coupled to said controller for storing a plurality of data, wherein said plurality of data is encrypted by said controller in said emergency mode.

6. The electronic device as claimed in claim 1, further comprising:
a memory coupled to said controller for storing a plurality of data, wherein said plurality of data is transferred to an external electronic device in said emergency mode.

7. The electronic device as claimed in claim 1, further comprising:
a memory coupled to said controller for storing a plurality of data, wherein said plurality of data is erased in said emergency mode.

8. The electronic device as claimed in claim 1, further comprising:
a battery for powering said electronic device; and
an electromagnetic lock for locking said battery in said emergency mode.

9. The electronic device as claimed in claim 1, further comprising:
a memory for storing an RFID reader driver operated by said controller to control said RFID reader.

10. A method comprising:
detecting a radio frequency identification (RFID) tag by an RFID reader when a distance between said RFID tag and said RFID reader is within a predetermined range;
enabling an electronic device to operate at an emergency mode when said distance between said RFID tag and said RFID reader is beyond said predetermined effective range; and
locking said electronic device in said emergency mode.

11. The method as claimed in claim 10, further comprising:
encrypting data stored in said electronic device in said emergency mode.

12. The method as claimed in claim 10, further comprising:
transferring data stored in said electronic device to an external electronic device in said emergency mode.

13. The method as claimed in claim 10, further comprising:
erasing data stored in said electronic device in said emergency mode.

14. The method as claimed in claim 10, further comprising:
locking a battery of said electronic device in said emergency mode by an electromagnetic lock.

15. The method as claimed in claim 10, further comprising:
unlocking said electronic device by receiving an unlock password.

16. The method as claimed in claim 10, further comprising:
sounding an alarm in said emergency mode;

17. A system, comprising:
a radio frequency identification (RFID) reader for emitting radio frequency (RF) waves;
an RFID tag for receiving said RF waves and generating a response signal when a distance between said RFID reader and said RFID tag is within a predetermined range; and
a controller for enabling an electronic device to operate at an emergency mode in which said electronic device is locked when said distance between said RFID tag and said RFID reader is beyond said predetermined range.

18. The system as claimed in claim 17, wherein said electronic device comprises:
a speaker for sounding an alarm in said emergency mode.

19. The system as claimed in claim 17, wherein said electronic device comprises:
a keypad for inputting a user instruction, wherein said keypad is locked in said emergency mode.

20. The system as claimed in claim 17, wherein said emergency mode is relieved if a correct unlock password is inputted to said keypad.

21. The system as claimed in claim 17, wherein said electronic device comprises a mobile phone which further comprises a subscriber identity module (SIM) card, and wherein said SIM card is locked in said emergency mode.

22. The system as claimed in claim 21, wherein said SIM card stores a plurality of SIM data, and wherein said SIM data is transferred to an external mobile phone in said emergency mode.

23. The system as claimed in claim 21, wherein said RFID tag is integrated in said SIM card.

24. The system as claimed in claim 17, wherein said electronic device comprises:
a battery for powering said electronic device; and
an electromagnetic lock for locking said battery in said emergency mode.

25. The system as claimed in claim 17, wherein said electronic device comprises said RFID reader, and wherein said controller is coupled to said RFID reader.

26. The system as claimed in claim 17, wherein said electronic device comprises said RFID tag, and wherein said controller is coupled to said RFID tag.
